(19) United States
(12) Patent Application Publication
(10) Pub. No.: US 2023/0197963 A1
(43) Pub. Date: Jun. 22, 2023

(54) METHOD OF MAKING BATTERY ELECTRODES WITH IMPROVED CHARACTERISTICS

(71) Applicant: Arkema Inc., King of Prussia, PA (US)

(72) Inventors: Daniel B. KENT, King of Prussia, PA (US); Katherine S. PASTORE, King of Prussia, PA (US); Pa Nhia XIONG, King of Prussia, PA (US)

(21) Appl. No.: 17/926,154

(22) PCT Filed: May 25, 2021
(86) PCT No.: PCT/US2021/034015

§ 371 Date: Nov. 18, 2022

Related U.S. Application Data
(60) Provisional application No. 63/033,446, filed on Jun. 2, 2020.

(51) Int. Cl. H01M 4/62; H01M 4/04

(52) U.S. Cl. CPC H01M 4/623; H01M 4/0404; H01M 4/0471; H01M 4/625

(57) ABSTRACT

Disclosed is a method for producing a battery electrode using a low solution viscosity polymeric binder composition where the binder composition comprises a fluoropolymer.

### TECHNICAL FIELD

The present invention relates to a method of preparing an electrode slurry for lithium secondary batteries, a method of manufacturing an electrode including the same, and an electrode manufactured using the same.

### BACKGROUND OF THE INVENTION

Electrodes are used in energy storing devices, including but not limited to, batteries, capacitors, ultra-capacitors, non-aqueous-type secondary batteries and such.

Currently there are two primary means for producing electrodes: a “wet” method and a “dry” method. In the wet method, a polymeric binder in the form of a solvent solution or dispersion is blended with one or more active powdery electrode forming materials to form a slurry dispersion or paste. This dispersion or paste is then applied to one or both surfaces of an electroconductive substrate, and dried to form a coherent composite electrode layer. The electrode layer may then be calendered. This method is shown in U.S. Pat. Nos. 5,776,637 and 6,200,703, where a fluoropolymer binder is dissolved in NMP. In the dry method, the polymeric binder in the form of a powder is blended with one or more active powdery electrode forming materials, and then solvent is added to form a slurry dispersion or paste. The subsequent steps of application, drying, and calendering are the same as in the wet process. An example of one embodiment of the dry method is shown in https://doi.org/10.1016/j.powtec.2016.04.011.

WO2018174619A1 teaches that mixing a dispersing agent with small particle size active material will lower slurry viscosity, improve adhesion, and therefore allow for higher solids in the final electrode.

EP2908370B1 uses very high shear to first fragment polymer into lower MW segments and then deagglomerate conductive material to lower slurry viscosity.

U.S. Pat. No. 10,573,895 teaches adding the binder solution in two steps or using two different binders entirely: one in the first step with active material and carbon black for good dispersion; and a second as a rheology modifier to prevent drag lines during pattern coating. The first electrode slurry of U.S. Pat. No. 10,573,895 has active material and uses a binder solution of from 6 to 8% by weight.

U.S. Pat. No. 8,697,822 describes the polymerization of VDF in the presence of acid surfactants.

Optimal slurry behavior is essential for casting a good electrode for a battery. Adequate mixing and dispersion of the conductive material lead to better slurry flowability. At the same concentration, PVDF binder solutions with low solution viscosity will be less able to generate shear than those with high solution viscosity. To overcome this problem, the binder solution concentration of the lower solution viscosity PVDF was increased to a point higher than was possible with the high solution viscosity PVDF. With this modification, less NMP is required to give comparable slurry and electrode properties.

Surprisingly, it has been found that by using a low solution viscosity (less than 6000 cP measured at 9% solids in NMP) polymeric binder composition at a concentration equal to or greater than 10%, preferably equal to or greater than 11%, a higher solids electrode slurry (greater than 70% solids content, preferably greater than 72%, more preferably greater than 75%, still more preferably greater than 77%) can be achieved. In some embodiments, the electrode slurry has a solids content of greater than 80 weight %. Advantageously, this inventive electrode slurry exhibits a decrease in viscosity (measured at 10 sec⁻¹) of the electrode slurry of at least 10% and can be as much as 75% or more as compared to the same slurry made from a 4% solids binder solution. When the electrode slurry is cast and dried to produce an electrode, the electrode has improved adhesion to the electroconductive substrate as compared to the same slurry produced using the 4% solids binder solution.

By increasing binder solution concentration, the resulting electrode has satisfactory electrode properties (retaining discharge capacity of at least 75%, preferably at least 80% of initial capacity after 500 cycles.

Formulation at the high PVDF binder concentration (equal to or greater than 9 weight %, preferably equal to or greater than 10 weight %, preferably equal to or greater than 11 weight % and up to 25%) leads to improved slurry behavior, electrode adhesion, and battery performance.

### SUMMARY OF THE INVENTION:

The invention relates to a method of making an improved battery electrode comprising (a) providing a conductive material slurry comprising binder and conductive material wherein the binder is in a concentration of (at least 9 weight %, preferably at least 10 weight %, or at least 11 weight % of binder) (b) adding the active material to the conductive material slurry to produce an active material slurry and (c) optionally diluting the active material slurry; to produce an electrode slurry. In the case where no additional dilution is needed, the active material slurry will be the electrode slurry. The electrode slurry is coated on an electrode substrate to form an electrode. The polymeric binder is a low solution viscosity material comprising a polyvinylidine fluoride fluoropolymer.

There are various ways to prepare the conductive material slurry.

One method of preparing the conductive material slurry is by preparing a high solids binder solution (at least 9 weight %, preferably at least 10 weight %, at least 11 weight % of binder). The binder solution preferably consists essentially of binder dissolved in solvent. After dissolving the binder in the solvent, dry conductive material is then combined with the binder solution to form a conductive material slurry.

Another method of preparing the conductive material slurry is combining binder in dry form with conductive material in dry form to produce a dry blend and subsequently adding solvent to the dry blend to produce a high solids conductive material slurry. The solids content of the conductive material slurry is preferably at least 15 weight %, preferably at least 17 weight %, at least 20 weight %, or greater and can be as high as 34 weight % solids.

Preferably, the polymeric binder composition comprises a polyvinylidene fluoride polymer composition, “PVDF”. By using the low solution viscosity polymeric binder composition, Applicants have increased solids of the polymeric binder composition resulting in an increase of solids in the electrode slurry and an increase in peel strength of the cathode. The resulting electrode made using the method of the invention has improved adhesion.

Applicants have discovered a method to improve adhesion in a battery electrode. The method of the invention may provide better adhesion.

Preferably, the solids content of the electrode slurry is at least 75% by weight.

Aspects of the invention

Aspect 1. A method of producing an electrode slurry for battery the method comprising

(a) providing a conductive material slurry comprising binder, conductive material and solvent,
(b) adding active material to the conductive material slurry to form an active material slurry and
(c) optionally diluting the active material slurry with solvent to a final solids content: to form an electrode slurry,
wherein the PVDF binder has a solution viscosity of less than 6000 cP at 9% solids in NMP and at 25° C., at 3.36 sec⁻¹, and wherein the PVDF binder concentration in the conductive material slurry is at least 9 weight %, preferably at least 10 weight % solids, more preferably at least 11 weight % solids PVDF and up to 23 weight % solids based on the total weight of the binder and solvent.

Aspect 2. The method of aspect 1 wherein the steps to make the conductive material slurry of step (a) comprise

(p) providing a PVDF binder,
(q) dissolving said PVDF binder in solvent at a concentrate of at least 9 weight %, preferably at least 10 weight % solids, more preferably at least 11 weight % solids PVDF and up to 23 weight % solids to produce a binder solution, and
(r) combining a conductive material with said binder solution to form a conductive material slurry;

or alternatively

(s) providing a PVDF binder in dry form,
(t) providing a conductive material in dry form,
(u) combining the PVDF binder and the conductive material in dry form to form a dry blend, and
(v) adding solvent to the dry blend to dissolve the PVDF binder to form a conductive material slurry, and
wherein the ratio of conductive material to PVDF binder (by weight) is from 5:1 to 1:5.

Aspect 3. A method of producing an electrode, the method comprising the method of aspect 1 or 2 and further comprising the steps of

(e) applying said electrode binder slurry to at least one surface of an electroconductive substrate to form an electrode
(f) evaporating the organic solvent in the electrode-slurry composition to form a composite electrode layer on the electroconductive substrate.

Aspect 4. The method of any one of aspects 1 to 3 wherein the PVDF has a solution viscosity of less than 4000 cP.

Aspect 5. The method of any one of aspects 1 to 4 wherein the PVDF is acid functionalized.

Aspect 6. The method of any one of aspects 1 to 5 wherein said PVDF binder comprises a polyvinylidene fluoride polymer comprising at least 50% by weight vinylidene fluoride monomers, preferably at least 75% by weight vinylidene fluoride monomers.

Aspect 7. The method of any one of aspects 1 to 6 wherein the binder solids is at least 10% solids, more preferably at least 11% solids PVDF based on the amount of binder in solvent.

Aspect 8. The method of any one of aspects 1 to 7 wherein the conductive material is selected for the group consisting of, graphite fine powder and fiber, carbon black, thermal black, channel black, carbon fiber, carbon nanotubes, and acetylene black, and fine powder and fiber of metals, such as nickel and aluminum.

Aspect 9. The method of any one of aspects 1 to 7 wherein the conductive material comprises carbon black.

Aspect 10. The method of any one of aspects 1 to 9 wherein the ratio of conductive material to binder solids (by weight) is between 5:1 and 1:5, preferably 1:3 to 3:1.

Aspect 11. The method of any one of aspects 1 to 10 wherein the solids content of the electrode slurry is at least 75% by weight.

Aspect 12. The method of any one of aspects 1 to 11 wherein the solids content of the electrode slurry is at least 80% by weight.

Aspect 13. The method of any of aspects 1 to 12, wherein said active material are selected from the group consisting of an oxide, sulfide, phosphate or hydroxide of lithium and a transition metal; carbonaceous materials; and combinations thereof.

Aspect 14. The method of any one of aspects 1 to 3, wherein the conductive material comprises carbon black, wherein the binder solids is at least 10% solids, more preferably at least 11% solids based on the amount of PVDF in solvent, wherein the PVDF binder has a solution viscosity of less than 4000 cP at 9% solids in NMP and at 25° C., at 3.36 sec⁻¹ and wherein the PVDF is acid functionalized.

Aspect 15. An electrode formed by the method of any one of aspects 3 to 14.

Aspect 16. A battery comprising the electrodes produced by the method of any one of aspects 3 to 14.

### DETAILED DESCRIPTION OF THE INVENTION

As used herein, copolymer refers to any polymer having two or more different monomer units, and would include terpolymers and those having more than three different monomer units.

Percentages, as used herein are weight percentages, unless noted otherwise.

The references cited in this application are incorporated herein by reference.

Solution viscosity is measured at 25° C. using Brookfield DVII viscometer, SC4-25 spindle at 3.36 sec⁻¹.

Slurry viscosity is measured at 25° C. using Brookfield DVIII viscometer, CP-52 spindle at 10 sec⁻¹.

Weight percent binder can be calculated as (weight of binder)/(weight of solvent plus binder). Same formula can be used regardless of what additional solids are present in the solution or a slurry.

The manner of practicing the invention will now be generally described with respect to a specific preferred embodiment thereof, namely polyvinylidene fluoride based polymers prepared in aqueous emulsion polymerization, although the invention has been generally illustrated with respect to PVDF polymers.

The invention provides for a method of making an electrode slurry composition and a method of making an electrode comprising said electrode slurry composition.

It has surprisingly been found that the use of a polymeric binder composition having a solution viscosity of less than 6000 cP, preferably less than 5000 cP and more preferably less than 4000 cP measured at 9 weight % solids in NMP at 25C at 3.36 sec⁻¹ provides for higher solids content in a conductive material slurry, and higher solids content in an electrode slurry. A lower viscosity in the electrode slurry with equivalent solids content can be achieved by using higher binder solids in the preparation of the conductive material slurry.

The present invention provides a method of preparing an electrode slurry for secondary batteries, including: preparation of a conductive material slurry, preparation of an active material slurry comprising the conductive material slurry, wherein the binder concentration in the conductive material slurry is at least 9 weight % based on the binder and the solvent, preferably at least 10 weight % or more.

The invention relates to a method of making an improved battery electrode comprising (a) providing a conductive material slurry comprising binder and conductive material wherein the binder is in a concentration of at least 9 weight %, preferably at least 10 weight %, or at least 11 weight % of binder (b) adding the active material to the conductive material slurry to produce an active material slurry and (c) optionally diluting the active material slurry; to produce an electrode slurry. The electrode slurry is coated on an electrode substrate to form an electrode. The polymeric binder is a low solution viscosity material comprising a polyvinylidene fluoride fluoropolymer.

The electrode active material and the conductive material are mainly used (added to the slurry) in a powder or paste state.

In one embodiment, the conductive material slurry is prepared by combining a high solids binder solution and the conductive material and mixing. The solvent and binder are combined to prepare a high binder solution such that the binder is dissolved in the solvent. The weight percent of binder should be at least 9 weight %, preferably at least 10 weight % or more and then, after dissolution of the binder, the conductive material is added thereto and mixed to provide a conductive material slurry.

Another method of preparing the conductive material slurry is combining binder in dry form with conductive material in dry form to produce a dry blend and subsequently adding solvent to the dry blend to produce the conductive material slurry. The percent of binder based on the final amount of solvent is at least 9 weight %, preferably at least 10 weight % or more.

Another method would be to partially dissolve the binder, add the conductive material, and then fully dissolve the binder. Another method would to be alternately combine binder and conductive material with solvent. Other iterations of preparing the conductive material slurry are possible. Regardless of how the conductive slurry is prepared, it must have percent of binder based on the final amount of solvent of at least 9 weight %, preferably at least 10 weight % or more.

The binder is a low solution viscosity PVDF.

In preferred embodiments, the PVDF is acid functionalized.

By using a low solution viscosity PVDF to disperse the conductive material, less solvent (such as NMP) is required. It is preferred that the final electrode has no added dispersant or additive, which maximizes the energy density in the resultant battery. Energy input during formulation does not need to be increased to maximize shear on the polymer or conductive material.

The low solution viscosity PVDF has a lower and upper bound of solution viscosity. At 9% solution concentration, the 1000 cP<solution viscosity<6000 cP (measured at 25° C. and 3.36 sec⁻¹). Below 1000 cP, PVDF polymer does not have adequate adhesion even with the invention method. Above 6000 cP, the solution viscosity cannot be increased by increasing the concentration to an appreciable level. This formulation modification can be used for any application in which the dispersion of high surface area materials is desired with less solvent required.

The binder solution may have a weight ratio of solvent to solid content between approximately 95:5 and approximately 80:20, preferably 90:10 to 80:20.

The ratio of binder to conductive material is from 5:1 to 1:5, preferably 3:1 to 1:3.

Preferably, the conductive material is carbon black.

According to an embodiment of the present invention, the solid concentration of the electrode slurry is greater than 71%, and preferably in the range of 71 to 87%, preferably 72 to 85%.

Accordingly, in the present invention, higher solids content can be obtained, and less solvent is used.

Here, the solid content refers to the weight ratio of the solid components in a slurry with respect to the total weight of the slurry, which is calculated as (weight of solid component)/(weight of solid component+weight of liquid component) according to each amount of the components actually used, and measured by a method of drying the slurry in an oven to remove all solvent and measuring the remaining weight.

The binder solution comprises a PVDF resin that is fully dissolved in solvent (preferably NMP) at ambient temperature at greater than 11% concentration, preferably greater than 12%. The PVDF can be dissolved at a weight percent of up to 20%, preferably up to 17%.

The viscosity of the electrode slurry of the present invention is in the range of 1000 to 5000 cP, measured using Brookfield DVIII viscometer with CP-52 spindle at 25° C. at 10 sec⁻¹ shear rate, through which physical properties of resulting electrode are optimal.

The fluoropolymer polymeric binder composition is preferably a fluoropolymer composition with acid functional groups. PVDF is a preferred fluoropolymer.

In one embodiment of the present invention, the binder solution is greater than 10 weight % polymeric binder preferably greater than 11 weight % polymeric binder in solvent. The conductive material is added into the binder solution at a ratio of conductive material to polymer binder from 5:1 to 1:5, preferably from 1:3 to 3:1 to create the conductive material slurry. The solids content in the conductive material slurry is preferably greater than 12 weight % solids, preferably greater than 15 weight %, preferably greater than 18 weight %. The active material is subsequently added to the conductive material slurry. When active material is added the solids content can go up to 90% or more creating the active material slurry. The active material slurry is then optionally diluted with solvent until castable, between 71 and 87%, preferably between 75 and 83% to create the electrode slurry. The active material slurry does not need to be diluted if the viscosity and solids level is acceptable for casting. In the case where the active material slurry does not need to be diluted, the active material slurry and the electrode slurry are the same.

In one embodiment using a PVDF acid functionalized copolymer having from 0.05 to 2 weight percent of acid monomer units in the polymer with a low solution viscosity in NMP (<6000 cP at 9 weight %), measured using Brookfield DVII viscometer SC4-25 spindle at 25° C. at 3.36 sec⁻¹, the binder concentration in solution can be raised to greater than 16%. At higher concentrations of polymer solids (greater than 9, preferably greater than 10 weight% polymer solids), more shear is imparted on the conductive material in the battery slurry, leading to improved slurry behavior, higher adhesion to current collector substrate, and enhanced electrochemical behavior in a battery. Other similar copolymers made by suspension polymerization have a solubility limit of <10, <11, <12% and therefore cannot meet the same reduction in NMP usage and gains in performance.

### Fluoropolymers

The invention applies to vinylidene fluoride homopolymers, and copolymers having greater than 50 weight % of vinylidene fluoride monomer units by weight, preferably more than 65 weight %, more preferably greater than 75 weight % and most preferably greater than 90 weight % of vinylidene fluoride monomers.

Vinylidene fluoride polymers copolymers include those containing at least 50 weight %, preferably at least 75 weight %, more preferably at least 80 weight %, and even more preferably at least 90 weight % of vinylidene fluoride copolymerized with one or more comonomers. Example comonomers may be selected from the group consisting of tetrafluoroethylene (TFE), trifluoroethylene (TrFE), chlorotrifluoroethylene (CTFE), 1,2-difluoroethylene, perfluorobutylethylene (PFBE), hexafluoropropene (HFP), vinyl fluoride (VF), pentafluoropropene, tetrafluoropropene, trifluoropropene, fluorinated (alkyl) vinyl ethers, such as, perfluoroethyl vinyl ether (PEVE), and perfluoro-2-propoxypropyl vinyl ether, perfluoromethyl vinyl ether (PMVE), perfluoropropyl vinyl ether (PPVE), perfluorobutylvinyl ether (PBVE), longer chain perfluorinated vinyl ethers, and any other monomer that would readily copolymerize with vinylidene fluoride, one or more of partly or fully fluorinated alpha-olefins such as 3,3,3-trifluoro-l-propene, 2-trifluoromethyl-3,3,3-trifluoropropene, 1,2,3,3,3- pentafluoropropene, 3,3,3,4,4-pentafluoro-l-butene, hexafluoroisobutylene (HFIB), fluorinated dioxoles, such as perfluoro(1,3-dioxole) and perfluoro(2,2-dimethyl-1,3-dioxole) (PDD), partially- or per-fluorinated alpha olefins of C4 and higher, partially- or per-fluorinated cyclic alkenes of C3 and higher, allylic, partly fluorinated allylic, or fluorinated allylic monomers, such as 2-hydroxyethyl allyl ether or 3-allyloxypropanediol, and ethene or propene and combinations thereof. Other monomers units in these polymers may include any monomer that contains a polymerizable C═C double bond. Additional monomers could be 2-hydroxyethyl allyl ether, 3-allyloxypropanediol, allylic monomers, ethene or propene, acrylic acid, methacrylic acid.

In one preferred embodiment the fluoropolymer is an acid functionalized fluoropolymer preferably acid functionalized PVDF.

Methods of producing acid functionalized fluoropolymers are known in the art. WO2019199753, WO2016149238 and U.S. Pat. No. 8,337,725, the content of each are herein incorporated by reference, provide some known methods of producing acid functionalized fluoropolymers.

In one embodiment, up to 30%, preferably up to 25%, and more preferably up to 15% by weight of hexafluoropropene (HFP) units and 70% or greater, preferably 75% or greater, more preferably 85% or greater by weight or more of VDF units are present in the vinylidene fluoride polymer. It is desired that the HFP units be distributed as homogeneously as possible to provide PVDF-HFP copolymer with excellent dimensional stability in the end-use environment.

Most preferred copolymers and terpolymers of the invention are those in which vinylidene fluoride units comprise greater than 50 percent of the total weight of all the monomer units in the polymer, preferably at least 60 weight %, and more preferably, comprise greater than 70 percent of the total weight of the units. Copolymers, terpolymers and higher polymers of vinylidene fluoride may be made by reacting vinylidene fluoride with one or more comonomers listed above.

### Polymerization Process

Fluoropolymers, such as polyvinylidene-based polymers, can be made by any process known in the art, using aqueous free-radical emulsion polymerization—although suspension, solution and supercritical CO₂ polymerization processes may also be used. Processes such as emulsion and suspension polymerization are preferred and are described in U.S. Pat. No. 6,187,885, and EP 0120524. It is preferred that the polymeric binder is made by emulsion polymerization.

In a general emulsion polymerization process, a reactor is charged with deionized water, water-soluble surfactant capable of emulsifying the reactant mass during polymerization and optional paraffin wax antifoulant. The mixture is stirred and deoxygenated. A predetermined amount of chain transfer agent, CTA, is then introduced into the reactor, the reactor temperature raised to the desired level and monomer (for example vinylidene fluoride and possibly one or more comonomers) are fed into the reactor. Once the initial charge of monomer is introduced and the pressure in the reactor has reached the desired level, an initiator is introduced to start the polymerization reaction. The temperature of the reaction can vary depending on the characteristics of the initiator used and one of skill in the art will know how to do so. Typically, the temperature will be from about 30° to 150° C., preferably from about 60° to 120° C. Once the desired amount of polymer has been reached in the reactor, the monomer feed will be stopped, but initiator feed is optionally continued to consume residual monomer. Residual gases (containing unreacted monomers) are vented and the latex recovered from the reactor.

The surfactant used in the polymerization can be any surfactant known in the art to be useful in PVDF emulsion polymerization, including perfluorinated, partially fluorinated, and non-fluorinated surfactants. Preferably, the PVDF emulsion is fluorosurfactant free, with no fluorosurfactants being used in any part of the polymerization. Non-fluorinated surfactants useful in the PVDF polymerization could be both ionic and non-ionic in nature including, but are not limited to, 3-allyloxy-2-hydroxy-1-propane sulfonic acid salt, polyvinylphosphonic acid, polyacrylic acids, polyvinyl sulfonic acid, and salts thereof, polyethylene glycol and/or polypropylene glycol and the block copolymers thereof, alkyl phosphonates and siloxane-based surfactants.

The polymerization results in a latex generally having a solids level of 10 to 60 percent by weight, preferably 10 to 50%, and having a weight average particle size of less than 500 nm, preferably less than 400 nm, and more preferably less than 300 nm. The weight average particle size is generally at least 20 nm and preferably at least 50 nm.

To be used in the present invention the PVDF latex is recovered in a dry form such as a powder form or granulated form.

In some embodiments, the binder is a fluoropolymer composition and has a melting point above 100° C., preferably above 145° C., preferably greater than 155° C.

### Electrode Slurry

Cathode electrode slurries comprise solvent, an active material and a conductive material and polymeric binder. The active material and conductive material are preferably, dry and powdery.

Any suitable organic solvent that dissolves the polymeric binder may be used. The organic solvent used for dissolving the polymeric binder composition (preferably a fluoropolymer, more preferably vinylidene fluoride polymer composition) to provide the binder solution according to the present invention may preferably be a polar one, examples of which may include: N-methyl-2-pyrrolidone (NMP), N-ethyl-2-pyrrolidone, dimethylformamide (DMF), N,N-dimethylacetamide, N,N-dimethylsulfoxide, hexamethylphosphamide, dioxane, tetrahydrofuran, tetramethylurea, triethyl phosphate, Cyrene™ from MilliporeSigma, and trimethyl phosphate. These solvents may be used singly or in mixture of two or more. The polymeric binder composition is dissolved in the solvent to make a polymeric binder solution.

In the case of forming a positive electrode (cathode), the cathode active material may comprise a composite metal chalcogenide represented by a general formula of LiMY₂, wherein M denotes at least one species of transition metals such as Co, Ni, Fe, Mn, Cr and V; and Y denotes a chalcogen, such as O or S. Among these, it is preferred to use a lithium-based composite metal oxide represented by a general formula of LiMO₂, wherein M is the same as above. Preferred examples thereof may include: LiCoO₂, LiNiO₂, LiNiₓCo₁₋ₓO₂,and spinel-structured LiMn₂O₄. Among these, it is particularly preferred to use a Li—Co or Li—Ni binary composite metal oxide or Li—Ni—Co ternary composite metal oxide inclusively represented by a formula of LiNiₓCo₁₋ₓO₂(0≤x≤1) in view of a high charge-discharge potential and excellent cycle characteristic. Cathode active materials include but are not limited to LiCoO₂, LiNi₁₋ₓCoₓO₂,Li₁₋ₓNi_{1-y}Co_{y}O₂, LiMO₂(M=Mn, Fe), Li[NiₓCo₁₋₂ₓMnₓ]O, LiNiₓMn_{y}Co_{z}O₂, LiM₂O₄(M=Ti, V, Mn), LiMₓMn₂₋ₓO₄ (M=Co²⁺, Ni²⁺, Mg²⁺, Cu²⁺, Zn²⁺, Al³⁺, Cr³⁺), LiFePO₄, LiMPO₄(M=Mn, Co, Ni) and LiNiₓCo_{y}Al_{z}O₂. Preferred positive electrode materials include, but are not limited to, LiCoO₂, LiNiₓCo₁₋ₓO₂, LiMn₂O₄, LiNiO₂, LiFePO₄, LiNiₓCo_{y}Mn_{z}Oₘ, LiNiₓ₋Co_{y}Al_{z}Oₘ where x+y+z=1 and m is an integer representing the number of oxygen atom in the oxide to provide an electron-balanced molecule; as well as lithium-metal oxides such as lithium cobalt oxide, lithium manganese oxide, lithium nickel manganese cobalt oxide, lithium nickel cobalt aluminum oxide, lithium nickel oxide, and lithium manganese oxide.

A lithium transition metal oxide with a non-stoichiometric amount of lithium may preferably be used as the positive electrode active material according to an embodiment of the present invention, and an example thereof may be a mixture of one or more selected from the group consisting of LiₓCoO₂ (0.5<x<1.3), LiₓNiO₂ (0.5<x<1.3), LiₓMnO₂ (0.5<x<1.3), LiₓMn₂O₄(0.5<x<1.3), Liₓ(NiₐCo_{b}Mn_{c})O₂ (0.5<x<1.3, 0<a<1, 0<b<1, 0<c<1 and a+b+c=1), LiₓNi_{1-y}Co_{y}O₂ (0.5<x<1.3, 0<y<1), LiₓCo_{1-y}Mn_{y}O₂ (0.5<x<1.3, 0≤y<1), LiₓNi_{1-y}Mn_{y}O₂ (0.5<x<1.3, 0≤y<1), Liₓ(NiₐCo_{b}Mn_{c})O₄ (0.5<x<1.3, 0<a<2, 0<b<2, 0<c<2 and a+b+c=2), LiₓMn_{2-z}Ni_{z}O₄ (0.5<x<1.3, 0<z<2), LiₓMn_{2-z}Co_{z}O₄ (0.5<x<1.3, 0<z<2), LiₓCoPO₄ (0.5<x<1.3), and LiₓFePO₄ (0.5<x<1.3), and more preferably, may be Liₓ(NiₐCo_{b}Mn_{c})O₂ (0.9<x<1.2, 0.5≤a≤0.7, 0.1≤b≤0.3, 0.1≤c≤0.3 and a₊b₊c=1).

Conductive material may preferably be used in an amount of 0.1-10 weight parts per 100 weight parts of the active material constituting the positive electrode (cathode). Conductive agents include but are not limited to carbonaceous materials, such as, graphite fine powder and fiber, carbon black, Super P® carbon black, C-NERGY™ carbon black, KETJENBLACK, DENKA BLACK, thermal black, channel black, carbon fiber, carbon nanotubes, and acetylene black, and fine powder and fiber of metals, such as nickel and aluminum. For electroconductive carbon black, the primary particle size of the carbon black preferably has an average particle size (diameter) of between 10-100 nm as measured by observation through an electron microscope. The primary particles can form aggregates or agglomerates up to 100 μm. The preferred conductive material is carbon black.

The electrode slurry may optionally contain other additives. Preferably, the electrode slurry does not contain additives. Such additives are known by those skilled in the art. The binder composition of the invention may optionally include 0 to 15 weight percent based on the polymer, and preferably 0.1 to 10 weight percent, of additives, including but not limited to thickeners, pH adjusting agents, acid, rheology additives, anti-settling agents, surfactants, wetting agents, fillers, anti-foaming agents, and fugitive adhesion promoters. Additional adhesion promoters may also be added to improve the binding characteristics and provide connectivity that is non-reversible.

### Forming the Electrode

The electrode slurry composition may be used for forming an electrode structure. More specifically, the electrode slurry composition may be applied onto at least one surface, preferably both surfaces, of an electroconductive substrate and dried at, e.g., 50-170° C., to form a composite electrode layer. Any metal having high conductivity and no reactivity in a voltage range of the battery may be used as the metal current collector, which allows the electrode slurry to be easily adhered thereto. Such substrates include a foil or wire net of a metal, non-limiting example includes iron, stainless steel, steel, copper, lithium, aluminum, nickel, silver or titanium or combinations thereof. The electrode slurry coating generally is from 10-1000 μm, preferably 10-200 μm, in thickness. Depending on use, the coating can be thicker or thinner.

The components of the electrode slurry are combined according to the invention to form a homogenous slurry. Example equipment used to combine the components include but are not limited to ball mills, magnetic stirrers, planetary mixers, high speed mixers, homogenizers and static mixers. A person of skill in the art can select adequate equipment for the purpose.

The solid content (%) of the electrode slurry is preferably in the range of 71 to 87 weight %, more preferably about 75 to 85 weight %. The solid content (%) of the electrode slurry can be between 80 weight % and 87 weight %.

The formulation for a cathode among active materials, conductive agent and polymeric binder can vary. Preferably, the amount of active material is about 90-99% by weight based on total solids; the amount of conductive agent is about 0.5 to 5% by weight based on total solids and the amount of polymeric binder is about 0.5 to 5% by weight based on total weight of active material, conductive agent and polymeric binder composition.

### Uses

The electrodes formed by the method of the invention can be used to form electro-chemical devices, including but not limited to batteries, capacitors, and other energy storage devices.

More specifically, the secondary battery such as a lithium secondary battery, basically includes a structure including a positive electrode, a negative electrode and a separator disposed between the positive and negative electrodes. The battery of the present invention may be manufactured using conventional methods known in the art.

The lithium secondary battery may be manufactured by interposing a porous separator between the positive electrode and the negative electrode, and adding an electrolytic solution in which a lithium salt is dissolved thereto. The separator may be formed of a porous polymer film. Separators for lithium batteries are well known in the art. The separator comprising a fine porous film of a polymeric material, such as PVDF, polyethylene or polypropylene, is generally impregnated with an electrolytic solution. In some embodiments, the separator can be extruded or casted directly onto the electrode and not be freestanding.

The non-aqueous electrolyte solution impregnating the separator may comprise a solution of an electrolyte, such as a lithium salt, in a non-aqueous solvent (organic solvent). Examples of the electrolyte may include: lithium salt, and an anion of the lithium salt may be one or more selected from the group consisting of F⁻, Cl⁻, Br⁻, I⁻, NO₃⁻, N(CN)₂⁻, BF₄⁻, ClO₄⁻, PF₆⁻, (CF₃)₂PF₄⁻, (CF₃)₃PF₃⁻, (CF₃)₄PF₂⁻, (CF₃)₅PF⁻, (CF₃)₆P⁻, F₃SO₃, CF₃CF₂SO₃⁻, (CF₃SO₂)₂N⁻, (FSO₂)₂N^{-l , CF}₃CF₂(CF₃)₂CO⁻, (CF₃SO₂)₂CH⁻, (SF₃)₃C⁻, (CF₃SO₂)₃C⁻, CF₃(CF₂)₇SO₃⁻, CF₃CO₂⁻, CH₃CO₂⁻, SCN⁻, and (CF₃CF₂SO₂)₂N⁻. Examples include LiPF₆, LiAsF₆, LiClO₄, LiBF₄, CH₃SO₃Li, CF₃SO₃Li, LiN(SO₂CF₃)₂, LiC(SO₂CF₃)₃, LiCl, and LiBr.

Examples of the organic solvent for such an electrolyte may include: propylene carbonate, ethylene carbonate, 1,2-dimethoxyethane, 1,2-diethoxyethane, dimethyl carbonate, diethyl carbonate, methyl ethyl carbonate, γ-butyrolactone, methyl propionate, ethyl propionate, dipropyl carbonate, dimethyl sulfoxide, acetonitrile, tetrahydrofuran, N-methyl-2-pyrrolidone (NMP), fluoroethylene carbonate (FEC), methyl formate, ethyl formate, propyl formate, methyl acetate, ethyl acetate, propyl acetate, pentyl acetate, and butyl propionate, and mixtures of these, but they are not exhaustive.

In another example the secondary battery such as a lithium secondary battery, comprises a structure including a positive electrode, a negative electrode and a solid state electrolyte disposed between the positive and negative electrodes. In this case, the solid state electrolyte also replaces the porous polymer separator. The mobile ion is lithium. Examples of solid inorganic electrolyte may include: lithium sulfides, lithium oxides, lithium phosphates, lithium nitrates, and lithium hydrides. Solid polymer electrolytes may contain particles of inorganic electrolyte or lithium salts. Polymers used in the formation of solid polymer electrolytes may include: polyethylene oxide, polyvinylidene fluoride, polyethylene glycol, and polyacrylonitrile, among others.

Further, the present invention provides a method of manufacturing an electrode, which includes applying the above-described electrode slurry onto at least one surface of an electrode current collector to form an electrode active material layer, an electrode manufactured by the above-described method, and a lithium secondary battery including the above-described electrode.

The electrode according to an embodiment of the present invention may be prepared by conventional methods known in the related field. For example, the electrode slurry may be applied on a current collector formed of a metal material, compressed and dried to produce an electrode.

The lithium secondary battery according to an embodiment of the present invention may include general lithium secondary batteries such as a lithium metal secondary battery, a lithium ion secondary battery, a lithium polymer secondary battery, a lithium ion polymer secondary battery, etc.

### EXAMPLES

### Example 1: Solubility Limits

Solubility of binder after rolling without heat for 96 hours is as follows.

PVDF1 is KYNAR® HSV 1810 polymer, an acid functionalized PVDF binder. The solution viscosity was measured as 3455 cP at 9 weight % in NMP.

PVDF1 was dissolved in NMP at ambient temperature at various concentrations by weight: 4%, 8%, 12% and 16% (based on total solution weight, polymer plus solvent). The PVDF1 dissolved fully at all concentrations. No coagulum or powder is visible in any of the samples.

Comparative PVDF2 is KF9700, an acid functionalized PVDF polymer from Kureha made by suspension polymerization. The 9% solution viscosity of KF9700 was measured as 8862 cP. Comparative PVDF2, is dissolved at 4 weight % and 8 weight %. Comparative PVDF2 has a solubility limit at 12%. Powder was clearly visible in the sample. Therefore, the polymer was past saturation.

Comparative PVDF3 is Solef® 5130, an acid functionalized PVDF polymer from Solvay made by suspension polymerization. The 9% solution viscosity of Solef® 5130 was measured as 9470 cP. Comparative PVDF3 has a solubility limit at 11.5 weight %.

### Example 2: Wet Mixing

The PVDF1 binder solution concentration is increased. A formulation schematic is described in Table 1 for a cathode prepared by the wet mixing method. Each column designates a separate formulation which ends at the same final solids value for comparison of slurry viscosity. Binder solution was prepared by dissolving the weight % PVDF binder in NMP. Three different weight % binders were prepared: 4%, 8% and 12%. Each binder solution was then used to make a slurry formulation.

TABLE 1
Formulations

| | Slurry Formulations | | | | | |
|---|---|---|---|---|---|---|
| Formulation | Slurry 1 | | Slurry 2 | | Slurry 3 | |
| Carbon Black | 0.42 | g | 0.42 | g | 0.42 | g |
| Binder solution | 4% | | 8% | | 12% | |
| concentration | | | | | | |
| PVDF Binder Solution | 10.5 | g | 5.25 | g | 3.50 | g |
| Binder Solution Viscosity | <200 | cP | 2200 | cP | 11640 | cP |
| Active Material | 27.16 | g | 27.16 | g | 27.16 | g |
| NMP Addition | | | 0.56 | mL | 0.56 | mL |
| NMP Addition | | | 0.56 | mL | 0.56 | mL |
| NMP | | | 1.12 | mL | 1.12 | mL |
| NMP | | | 1.12 | mL | 1.12 | mL |
| NMP | | | 1.76 | mL | 3.46 | mL |
| Final Solids | 73.5% | | 73.5% | | 73.5% | |
| Viscosity of the | 4842 | cP | 3155 | cP | 2143 | cP |
| electrode slurry | | | | | | |
| measured at 10 sec⁻¹ | | | | | | |

The wet mixing formulation is prepared using a Thinky ARE-310 mixer. After PVDF1 binder solution is added to the carbon black, seven 6.5 mm zirconium beads are added to the Thinky cup. The mixture is mixed for two minutes, three times, at 2000 RPM for a total of six minutes of mixing to generate the conductive material slurry. Active material is added along with the first addition of NMP. The active material slurry is mixed for one minute at 2000 RPM, two times. NMP is added and the active material slurry is mixed for one minute at 2000 RPM, two times. The remaining aliquots of NMP are added and mixed for one minute at 2000 RPM in between each addition to obtain the electrode slurry. The total mixing time of the entire formulation is 13 minutes.

The slurry viscosity was measured at 10 sec⁻¹ on a Brookfield DVIII viscometer with a CP-52 spindle at 25° C. The higher the binder solution concentration is at the beginning of the formulation, the lower the final electrode slurry viscosity is at the same solids level as shown in last entry of Table 1.

The resulting electrode slurry was cast onto aluminum foil using a doctor blade. The electrode was dried in an oven at 120° C. to evaporate NMP. The electrode was calendered and then was tested for physical properties, including adhesion and electrochemical performance.

Adhesion was measured in 180° peel test according to ASTM D903.

Peel at 4, 8, and 12% binder solution concentrations is described in Table 2. PVDF1 peel adhesion data shows the effect of using varying concentration of binder solutions.

TABLE 2

| Slurry | |
|---|---|
| (% Binder Solution used in slurry) | Peel Strength (N/m) |
| Slurry 1: (4%) | 78 |
| Slurry 2 (8%) | 125 |
| Slurry 3: (12%) | 148 |

### Example 3: Dry Mixing

TABLE 3

| | Slurry Formulations | | | | | | | |
|---|---|---|---|---|---|---|---|---|
| | Slurry 4 | | | | Slurry 6 | | | |
| Formulation | Comparative | | Slurry 5 | | Comparative | | Slurry 7 | |
| Carbon Black | 0.42 | g | 0.42 | g | 0.34 | g | 0.34 | g |
| PVDF1 | 0.42 | g | 0.42 | g | 0.50 | g | 0.50 | g |
| NMP | 8.20 mL | | 3.0 mL | | 8.20 mL | | 3.0 mL | |
| | (8.46 gms) | | (3.1 gms) | | (8.46 gms) | | (3.1 gms) | |
| Conductive Material Slurry | 9 | | 21.4 | | 9 | | 21.4 | |
| Weight % Solids = (CB + | weight % | | weight % | | weight % | | weight % | |
| PVDF)/(CB + PVDF + NMP). | | | | | | | | |
| Active Material | 27.16 | g | 27.16 | g | 27.16 | g | 27.16 | g |
| NMP Addition | 0.84 | mL | 0.84 | mL | 0.84 | mL | 0.84 | mL |
| NMP Addition | 0.42 | mL | 5.66 | mL | 0.42 | mL | 5.66 | mL |

| | | | | |
|---|---|---|---|---|
| Final Solids | 74.1% | 74.1% | 74.1% | 74.1% |

The dry mixing formulation as described in Table 3 is prepared using a Thinky ARE-310 mixer. Dry PVDF and dry carbon black are added to a Thinky cup. The solids are mixed for two minutes, two times, at 2000 RPM for a total of four minutes. NMP is added to the cup and mixed for four minutes, three times, at 2000 RPM for a total of twelve minutes to generate the conductive material slurry. Active material is added to the cup and mixed for one minute, two times at 2000 RPM. The remaining aliquots of NMP are added to the active material slurry and mixed for one minute at 2000 RPM in between each addition. The total mixing time of the electrode slurry is between 18-30 minutes depending on number of NMP dilution steps. Slurry 4 and Slurry 5 are formulated at a 1:1 ratio of CB/PVDF. Slurry 6 and Slurry 7 were made in a similar manner except the ratio of CB/PVDF is 1:1.5 .

The electrode slurry viscosity was measured at 10 sec⁻¹ on a Brookfield DVIII viscometer with a CP-52 spindle at 25° C. The higher the binder solution concentration is at the beginning of the formulation, the lower the final electrode slurry viscosity will be at the same solids level.

The resulting electrode slurry was cast onto aluminum foil using a doctor blade. The electrode was dried in an oven at 120° C. to evaporate NMP. The electrode was calendered and then was tested for physical properties, including adhesion and electrochemical performance.

Adhesion was measured in 180° peel test according to ASTM D903.

TABLE 4

| | | CB/PVDF | Slurry | | Peel |
|---|---|---|---|---|---|
| CB/PVDF | | in NMP | Viscosity @ 10 | Slurry | Strength |
| Ratio | Slurry | Concentration % | sec⁻¹ (cP) | Solids | (N/m) |
| 1:1 | 4 | 9 | 9882 | 74.1% | 14 |
| | Comparative | | | | |
| 1:1 | 5 | 21.4 | 1230 | 74.1% | 60 |
| 1:1.5 | 6 | 9 | 10438 | 73.5% | 68 |
| | Comparative | | | | |
| 1:1.5 | 7 | 21.4 | 1647 | 73.5% | 91 |

Table 4 contains slurry viscosity and peel data trends for two CB/PVDF ratios in the dry premixing process. These data show that increasing binder concentration decreases slurry viscosity and increases peel.

The electrode slurry viscosity decreased as the weight % binder solids in the conductive slurry increased.

The peel strength increased as the weight percent of binder solids (based on amount binder over the amount of binder plus solvent) used in the conductive slurry increased.

### Example 4: Coin Cell Performance

Coin cell batteries were made with cathodes using the method of the invention using PVDF1. Using electrode slurry with the same ratios as Electrode Slurry 5, but with an end solids content of 81 weight % solids (as opposed to 74.1%) to highlight the effect of high loading on battery performance. The 81% solids slurry was made using same ratio of active material as in slurry 5 but less NMP in the “NMP Additions”. The coin cells also contained conventional components for the graphite anode, carbonate-based electrolyte, and polyolefin separator.

The batteries were cycled in duplicate at 0.5C rate, 25° C. The electrode exhibits good initial DC resistance and capacity. After 500 cycles electrochemical performance is satisfactory.

| | Avg. Capacity at Cycle 50 | Avg. Capacity at Cycle 500 |
|---|---|---|
| Binder | (mAh/g) | (mAh/g) |
| PVDF1 | 154 | 131 |

After 500 cycles the battery retains over 85% capacity. This is superior performance. Anything over 80% is superior performance.

1. A method of producing an electrode slurry for battery comprising
(a) providing a conductive material slurry comprising binder, conductive material and solvent,
(b) adding active material to the conductive material slurry to form an active material slurry and
(c) optionally diluting the active material slurry with solvent to a final solids content: to form an electrode slurry,
wherein the PVDF binder has a solution viscosity of less than 6000 cP at 9% solids in NMP and at 25° C., at 3.36 sec⁻¹ and
wherein the PVDF binder concentration in the conductive material slurry is at least 9 weight %, and up to 23% solids based on the total weight of the binder and solvent.

2. The method of claim 1 wherein the steps to make the conductive material slurry of step (a) comprise
(p) providing a PVDF binder
(q) dissolving said PVDF binder in solvent at a concentrate of at least 9 weight % solids PVDF and up to 23% solids to produce a binder solution,
(r) combining a conductive material with said binder solution to form a conductive material slurry, or alternatively
(s) providing a PVDF binder in dry form
(t) providing a conductive material in dry form
(u) combining the PVDF binder and the conductive material in dry form to form a dry blend, and
(v) adding solvent to the dry blend to dissolve the PVDF binder to form a conductive material slurry,
and
wherein the ratio of conductive material to PVDF binder (by weight) is from 5:1 to 1:5.

3. A method of producing an electrode comprising the method of claim 1 and further comprising the steps of
(e) applying said electrode binder slurry to at least one surface of an electroconductive substrate to form an electrode, and
(f) evaporating the organic solvent in the electrode-slurry composition to form a composite electrode layer on the electroconductive substrate.

4. The method of claim 1, wherein the PVDF has a solution viscosity of less than 4000 cP.

5. The method of claim 1, wherein the PVDF is acid functionalized.

6. The method of claim 1, wherein said PVDF binder comprises a polyvinylidene fluoride polymer comprising at least 50% by weight vinylidene fluoride monomers.

7. The method of claim 1, wherein the binder solids is at least 10% solids PVDF based on the amount of binder and solvent.

8. The method of claim 1, wherein the conductive material is selected for the group consisting of, graphite fine powder, graphite fiber, carbon black, thermal black, channel black, carbon fiber, carbon nanotubes, acetylene black, fine powder of metals and fiber of metals.

9. The method of claim 1, wherein the conductive material comprises carbon black.

10. The method of claim 1, 3 wherein the ratio of conductive material to binder solids (by weight) is between 5:1 and 1:5.

11. The method of claim 1, wherein the solids content of the electrode slurry is at least 75% by weight.

12. The method of claim 1, wherein the solids content of the electrode slurry is at least 80% by weight.

13. The method of claim 1, wherein said active material are selected from the group consisting of an oxide, sulfide, phosphate or hydroxide of lithium and a transition metal; carbonaceous materials; and combinations thereof.

14. The method of claim 1, wherein the conductive material comprises carbon black, wherein the binder solids is at least 10% solids based on the amount of PVDF in solvent, wherein the PVDF binder has a solution viscosity of less than 4000 cP at 9% solids in NMP and at 25° C., at 3.36 sec⁻¹ and wherein the PVDF is acid functionalized.

15. An electrode formed by the method of claim 3.

16. A battery comprising the electrodes produced by the method of claim 3.
